(19) United States
(12) Patent Application Publication
(10) Pub. No.: US 2005/0188484 A1
(43) Pub. Date: Sep. 1, 2005

(54) Quick change roller replacement

(76) Inventor: Clifton Edward Lytle, Oklahoma City, OK (US)

Correspondence Address: BERENATO, WHITE & STAVISH, LLC, 6550 ROCK SPRING DRIVE, SUITE 240, BETHESDA, MD, 20817, US

(21) Appl. No.: 11/060,372

(22) Filed: Feb. 17, 2005

Related U.S. Application Data
(60) Provisional application No. 60/545,478, filed on Feb. 19, 2004.

(51) Int. Cl. B08B 1/04

(52) U.S. Cl. 15/52.1; 15/230; 15/230.12; 15/93.1

(57) ABSTRACT

A quick change roller replacement unit is formed as a pre-rolled tube that simply slides on and attaches to the roller of the wall scrubber. The roller replacement is formed primarily by two components; a coarse outer layer (e.g., conventional belting) and substrate tape (e.g., carpet seam tape). The substrate tape is wrapped around the roller in a helical manner with the temperature-sensitive adhesive on the outside. The coarse outer layer is then wrapped around the substrate tape in a matching helical manner while a heat gum applies the requisite heat to activate the temperature sensitive adhesive of the tape, whereby the tape and outer layer is heated to bond the coarse layer to the tape. The resulting structure provides a quick change roller replacement unit that can quickly and easily be used on a wall scrubber to scrub or sweep off excess material and oversprayed fiber when installing wall spray insulation.

### CROSS-REFERENCE TO RELATED APPLICATION

This Application claims the benefit under 35 U.S.C. 119(e) of U.S. Provisional Application No. 60/545,478 filed Feb. 19, 2004 by Clifton Edward Lytle.

### BACKGROUND OF THE INVENTION

1. Field of the Invention

The invention relates to a wall scrubber for loose-fill insulation systems and, more particularly, to a roller for use with the wall scrubbers.

2. Description of Related Art

Fiberglass batt installation typically requires the time consuming cutting up or shaping of batts when the need arises to fill abnormally shaped open cavities between studs, or insulate around electric boxes, wires, and the like. Furthermore, structures insulated with batts often suffer from less than desirable thermal and sound insulation due to the void areas sometimes found around the edges of the batts adjacent studs or other supporting structure.

An increasingly preferred method of installing insulation into a building or residential structure is the method of “blowing in” or spraying insulation particles mixed with adhesive into the space between the outer and inner walls of the structure. The aggregate of insulation particles and the adhesive is commonly referred to as loose fill insulation. The outer walls of the structure are typically composed of concrete, masonry, metal or alloy sheeting or wood. The inner walls are typically composed of drywall, paneling or plaster mounted on a backing. The outer walls may be mounted on the same support skeleton which supports the inner walls or they may be mounted on a separate support skeleton. A number of loose-fill insulation systems have been developed in an attempt to overcome these disadvantages inherent in residential fiberglass batt usage. FIGS. 1 and 2 show a typical system for delivering loose-fill insulation system where a pump-and-blower system delivers the insulation to the wall between conventional studs.

As is known in the art, the fiberglass loose-fill/dry adhesive mixture may be sprayed or blown into both enclosed and open cavities. As shown in FIGS. 1 and 2, the sprayed insulation mixture with activated adhesive adheres to or sticks to wall 32 which may be made of plywood, or any other known residential exterior insulating sheeting. Netting or other supporting structure may be needed to retain the sprayed on mixture in open cavity 5 as shown in FIG. 1. Each cavity is bounded on either side by vertical studs 17 and on the top and bottom by horizontal studs 19. These studs may be, for example, 2″×4″ as known in the trade. Open cavities 9 and 10 in FIG. 1 have been filled with the spray-on insulation while open cavities 21 have not (open cavity 5 is in the process of being filled).

As shown in FIG. 3, a wall scrubber 100 is a specialized tool designed to scrub or sweep off excess material and oversprayed fiber when installing wall spray insulation 1. The wall scraper utilizes belting 120 to provide a scrubbing surface.

Typically, a material 50 with a coarse surface (e.g., conveyor belting of rubber or other suitable material known to those of skill in the art) is wrapped around a tube 52 to create the scrubbing surface. In a conventional wall scrubber, the belting is attached to one end of the roller by a screw (not shown), then glued & wrapped around the tube 52 (see FIG. 4), finally being attached by a screw 54 at the other end. This is a difficult task trying to hold the belting, keep the wrapping tight, gluing, and attaching the loose end. This is very difficult to do on a jobsite, so if this needs to be done during a job, then the crew has to shut down, return to the shop, and change the pads there in the manner shown in FIG. 4.

The need therefore exists for a quick-change roller replacement unit formed as a prerolled tube that simply slides on and attaches to the wall scrubber. With such a device, the scrubber belting can be changed in a matter of minutes, and can be completed anywhere.

### SUMMARY OF THE INVENTION

A quick change roller replacement unit is formed as a pre-rolled tube that simply slides on and attaches to the roller of the wall scrubber. The roller replacement is formed primarily by two components; a sheet of coarse or abrasive material and substrate tape. The substrate tape (e.g., carpet seam tape) is wrapped around the roller in a helical manner with the temperature-sensitive adhesive on the outside. The sheets of coarse material are then wrapped around the substrate tape in a matching helical manner while a heat gum applies the requisite heat to activate the temperature sensitive adhesive of the tape, whereby the tape and belting is heated to bond the belting to the tape. The resulting structure provides a quick change roller replacement unit that can quickly and easily be used on a wall scrubber to scrub or sweep off excess material and oversprayed fiber when installing wall spray insulation.

The quick-change roller of this invention will be understood by those of skill in the art with reference to the following drawings and associated description.

### BRIEF DESCRIPTION OF THE DRAWINGS

FIG. 1 is a perspective view of the insulation being blown into a vertically extending cavity.

FIG. 2 is a side view of the insulation being blown into an enclosed cavity.

FIG. 3 is an illustration of a wall scrubber scrubbing a wall.

FIG. 4 is an illustration showing the unwrapping of the rubber belting on the traditional style roller for the wall scrubber of FIG. 3.

FIG. 5 is an illustration showing the sliding of the belting made according to this invention onto the roller of the wall scrubber.

FIG. 6 is an illustration showing a perspective view of an example of the belting made according to this invention.

FIG. 7 is a photograph showing the manufacturing process for the roller replacement device of this invention.

FIG. 8 is a photograph showing the manufacturing process for the roller replacement device of this invention shown from a different perspective than FIG. 7.

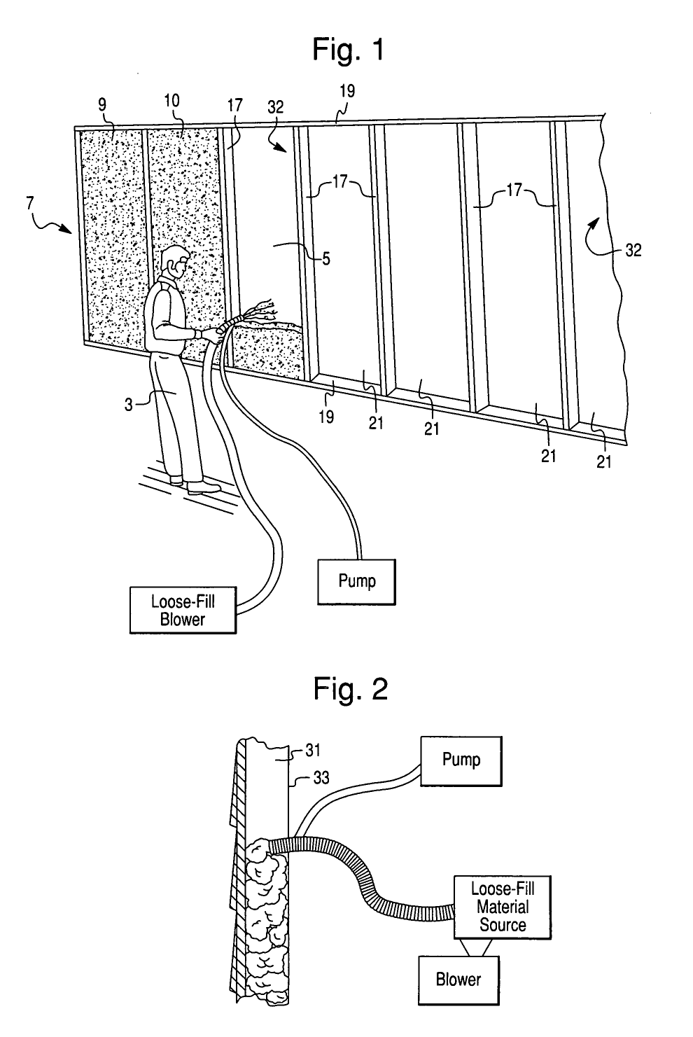

### DETAILED DESCRIPTION OF PREFERRED EMBODIMENT

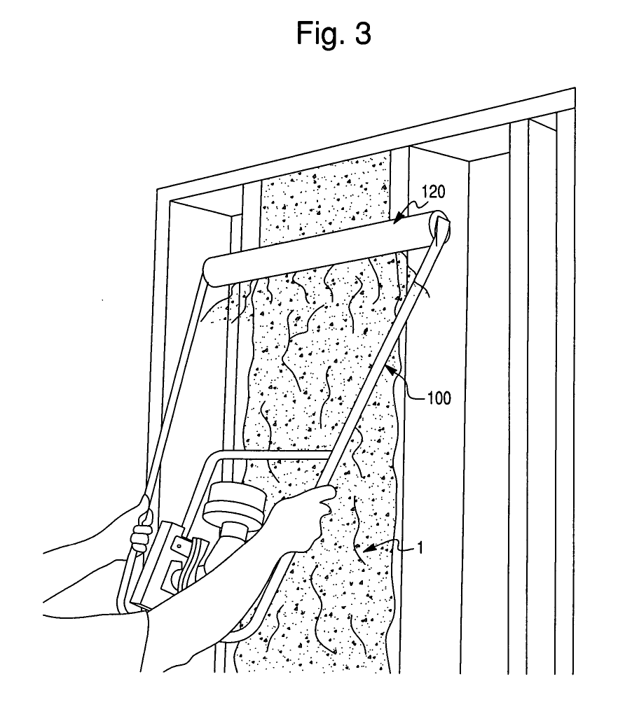

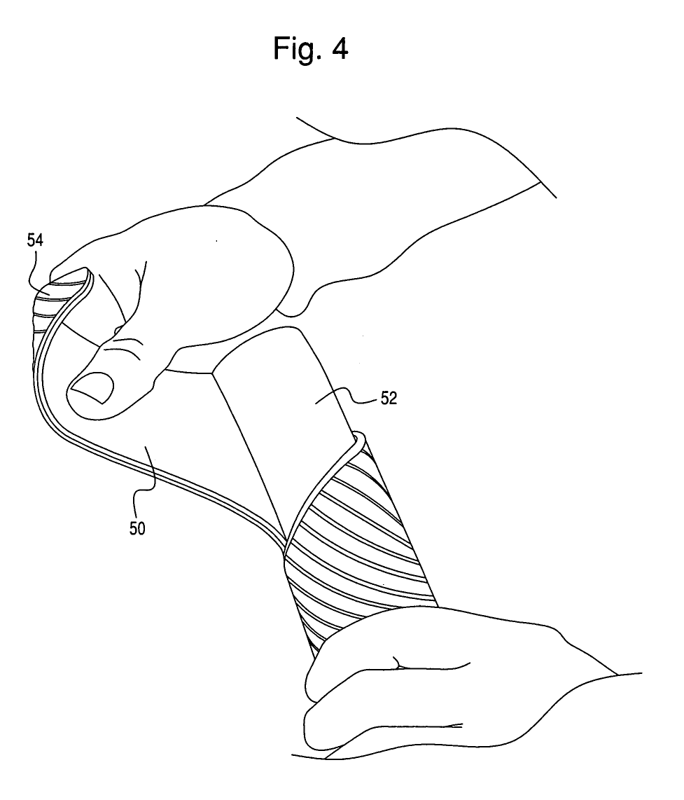

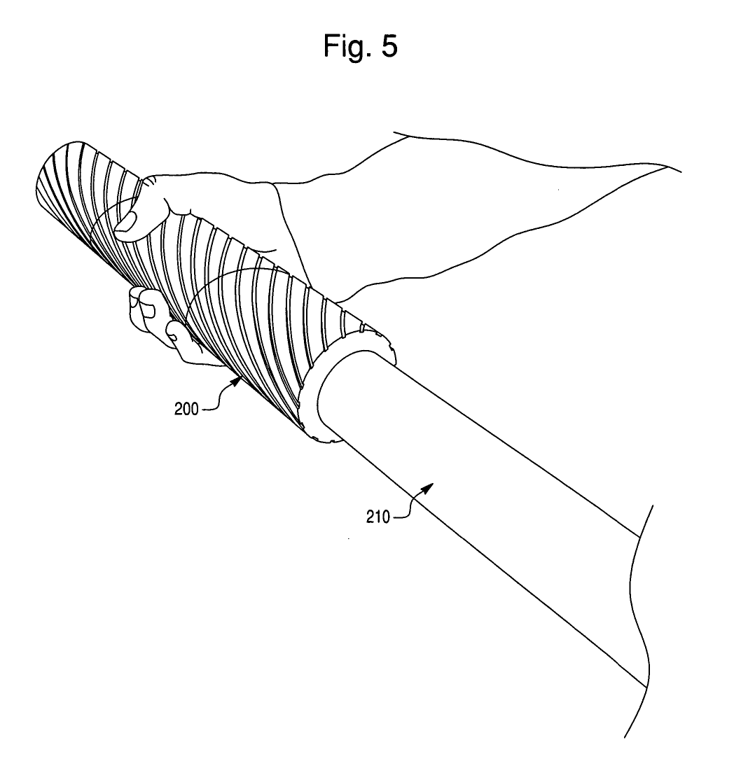

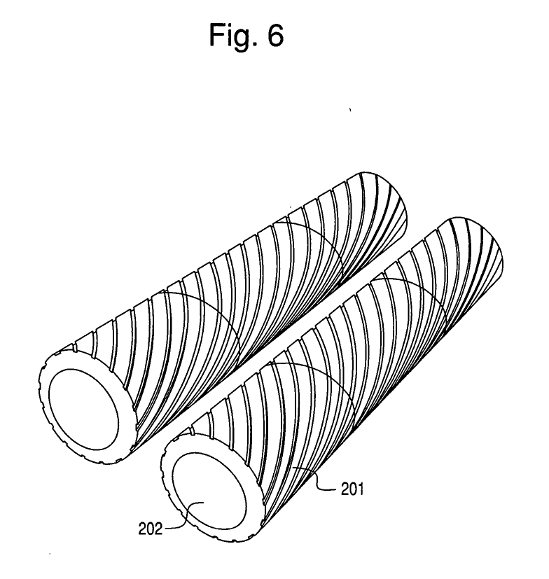

As shown in FIGS. 5 and 6, the invention is a quick change roller replacement unit 200 formed as a pre-rolled tube that simply slides on and attaches to the roller 210 of the wall scrubber (see FIG. 3). The roller replacement is formed primarily by two components; a coarse or abrasive outer layer 201 and substrate tape 202. In the preferred embodiment, the coarse outer layer is made of conventional conveyor belting with a woven rubber structure having an epoxy inner side and a coarse outer side. Of course, any suitable material may be selected for the coarse outer layer having a ribbed or nibbled rough surface. The substrate tape is preferably a carpet tape having a temperature-sensitive adhesive side disposed on a polymer or nylon backing. Of course, any suitable one sided tape of adhesive may be used; the object being to adhere the coarse outer layer to a substrate having a smooth interior surface to permit the quick change roller to be slid onto the scrubber roller.

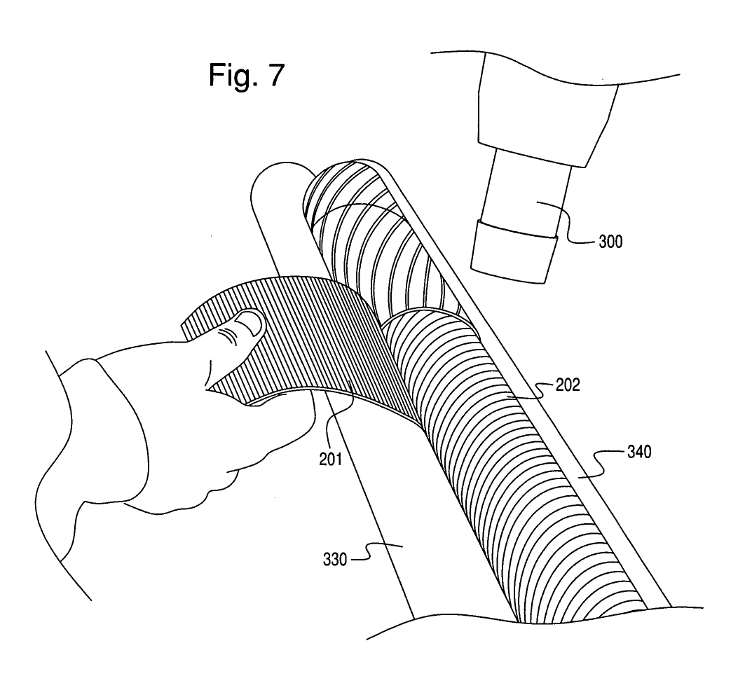

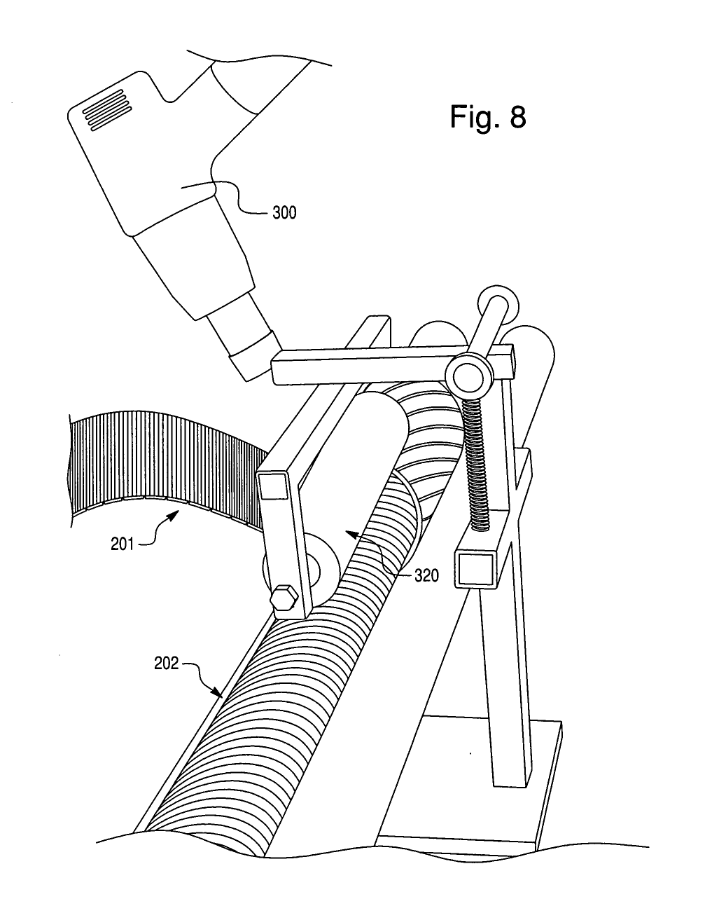

As shown in FIGS. 6 and 7, the adhesive tape 202 (e.g., carpet seam tape) is wrapped around the roller 210 in a helical manner with the temperature-sensitive adhesive on the outside; i.e., facing away from the roller 210. The coarse outer layer (e.g., conveyor belt pieces) are then wrapped around the tape in a matching helical manner while a heat gum 300 applies the requisite heat to activate the temperature sensitive adhesive of the tape, whereby the substrate tape and coarse outer layer is heated to bond the coarse material to the substrate tape. In the preferred manufacturing method, a spring-biased pressure roller 320 applies a pressure to the belting 201 to enhance the bolding effect of the coarse material 201 to the substrate tape 202. Further, the replacement unit 200 rides on a pair of alignment rollers 330, 340 to facilitate rolling of the replacement unit 200 during the manufacturing process.

The resulting structure, which is shown in FIGS. 5 and 6, provides a quick change roller replacement unit that can quickly and easily be used on a wall scrubber to scrub or sweep off excess material and oversprayed fiber when installing wall spray insulation.

While the invention has been shown and described with respect to a preferred design, it will be understood by those of skill in the art that various changes in form and detail may be made without departing from the spirit and scope of this invention.

1. A quick-change roller replacement unit for an insulation scrubber, comprising:
a substrate having a base and an adhesive layer disposed on said base, said substrate defining an annular shape having an inner diameter substantially matching a diameter of a roller for an insulation scrubber;
a coarse scrubber outer member having a woven structure with a backing portion facing said adhesive layer and a coarse outer layer, wherein said coarse outer layer is adapted to remove excess insulation from an insulated area.

2. The replacement unit of claim 1, wherein said adhesive layer is a temperature sensitive adhesive that is activated by the application of heat thereto.

3. The replacement unit of claim 1, wherein the base made from a flexible polymer material.

4. The replacement unit of claim 1, wherein the base is made from a nylon fabric.

5. The replacement unit of claim 1, wherein sad substrate defines a helical pattern.

6. The replacement unit of claim 1, wherein said coarse scrubber outer member defines a helical pattern.

7. The replacement unit of claim 1, wherein the backing portion is an epoxy-based material.

8. A combination insulation scrubber and roller replacement member for scrubbing off excess material and oversprayed fiber when installing spray insulation, said combination comprising:
a handle section adapted to be gripper by a user during a scrubbing operation;
a roller section fixed to said handle section to rotate with respect to the handle section;
a roller replacement member slidingly disposed on said roller section and affixed to said roller section via a fastener to rotate with respect to said handle section;
wherein said roller replacement member is a tubular member having a smooth interior and a coarse exterior, said coarse outer layer being adapted to remove excess insulation from an insulated area.

9. The combination according to claim 8, wherein said roller replacement member comprises a substrate having a base and an adhesive layer disposed on said base, said substrate defining an annular shape having an inner diameter substantially matching a diameter of a roller for an insulation scrubber; and a coarse scrubber outer member having a woven structure with an epoxy backing facing said adhesive layer and a coarse outer layer.

10. The combination according to claim 9, wherein said adhesive layer is a temperature sensitive adhesive that is activated by the application of heat thereto.

11. A method of manufacturing a quick-change roller replacement unit for an insulation scrubber, comprising the steps of:
disposing a substrate and an external adhesive layer on a roller member sized to match a size of an insulation scrubber;
wrapping a coarse scrubber outer member onto said substrate, said outer member having an outwardly facing woven structure and an inwardly facing backing facing said adhesive layer, said woven structure defining a coarse outer layer being adapted to remove excess insulation from an insulated area.

12. The method of claim 11, further comprising the step of applying heat to said adhesive layer which is a temperature sensitive adhesive that is activated by the application of heat thereto.

13. The method of claim 12, wherein said step of applying heat occur during said step of wrapping

14. The method of claim 11, wherein said substrate is disposed on said roller in a helical configuration.

15. The method of claim 11, wherein said coarse scrubber outer member is disposed on said substrate in a helical configuration.
